(19) United States
(12) Patent Application Publication
(10) Pub. No.: US 2015/0046787 A1
(43) Pub. Date: Feb. 12, 2015

(54) URL TAGGING BASED ON USER BEHAVIOR

(71) Applicant: International Business Machines Corporation, Armonk, NY (US)

(72) Inventors: Yoav Rubin, Haifa (IL); Omer Tripp, Har Adar (IL)

(73) Assignee: International Business Machines Corporation, Armonk, NY (US)

(21) Appl. No.: 13/959,788

(22) Filed: Aug. 6, 2013

(51) Int. Cl. G06F 17/22

(52) U.S. Cl. CPC G06F 17/2247
USPC 715/234

(57) ABSTRACT

A computerized method for tagging a resource locator based on user behavior statistics, comprising: collecting browsing data on at least one browsing action taken by each of a plurality of end users after browsing to a first web document, the first web document is referenced to by a resource locator in a second web document; analyzing, using a computerized processor, the browsing data to statistically identify a browsing characteristic of the first web document; and instructing the presentation of an indication of the browsing characteristic in association with the presentation of the second web document by a browser installed in a client terminal to a user browsing to the second web document.

### BACKGROUND

The present invention, in some embodiments thereof, relates to tagging a resource locator and, more particularly, but not exclusively, to tagging a resource locator based on user behavior statistics.

Internet users are often exploited when they click on a resource locator that directs to a malicious webpages, for example, for phishing purposes.

Existing ways of protecting users from these risks include, for example, analyzing the structure of the resource locator, analyzing the webpage directed by the resource locator for known patterns and databases containing users' opinions about the webpage's safety.

### SUMMARY

According to an aspect of some embodiments of the present invention there is provided.

According to an aspect of some embodiments of the present invention there is provided a computerized method for tagging a resource locator based on user behavior statistics, comprising: collecting browsing data on at least one browsing action taken by each of a plurality of end users after browsing to a first web document, the first web document is referenced to by a resource locator in a second web document; analyzing, using a computerized processor, the browsing data to statistically identify a browsing characteristic of the first web document; and instructing the presentation of an indication of the browsing characteristic in association with a presentation of the second web document by a browser installed in a client terminal to a user browsing to the second web document.

Optionally, the browsing data include a time duration spent by each of the plurality of end users at the first web document.

Optionally, the browsing data include a number of browsing actions performed by each of the plurality of end users at the first web document.

Optionally, the collecting comprise: compiling a group of socially affiliated users; and collecting browsing data from the group of socially affiliated users.

Optionally, the collecting is performed on some of the browsing data to minimize computing load.

Optionally, the collecting of browsing data is performed by a browser plugin installed on the browser.

Optionally, the analyzing further includes data obtained by scanning a to content of the first web document for patterns relating to the browsing characteristic.

Optionally, the analyzing further includes data concerning a posting of the resource locator on social networks.

Optionally, the analyzing further include analyzing browsing data of each of a plurality of end users after browsing to other web documents of the same website as the first web document.

Optionally, the analyzing further include browsing data of each of a plurality of end users after browsing to web documents linked from the first web document.

Optionally, the analyzing is performed on some of the browsing data to minimize computing load.

Optionally, the analyzing is performed by a central server after receiving the browsing data from a plurality of client terminals of the plurality of end users.

Optionally, the presenting is performed by a browser plugin installed on the browser.

Optionally, the presenting includes visual indication warning the user from browsing to the first web document.

Optionally, the presenting includes presenting of the analyzed browsing data.

Optionally, the method further comprises changing security definitions of the browser based on the browsing characteristic.

Optionally, the method further comprises at least one of preventing and containing an execution of a script by the first web document based on the tagging.

Optionally, there is provided a computer readable medium comprising computer executable instructions adapted to perform the method.

According to an aspect of some embodiments of the present invention there is provided a system for tagging a resource locator based on user behavior statistics, comprising: at least one data collection module which collects data on at least one browsing action taken by each of a plurality of end users after browsing to a first web document associated with a resource locator, the first web document is referenced to by a resource locator in a second web document; a computerized processor which analyzes the browsing data to statistically identify a browsing characteristic of the to first web document; and a presenting module which instructs the presentation of an indication of the browsing characteristic in association with the presentation of the second web document by a browser installed in a client terminal to a user browsing to the second web document.

Optionally, the system further comprises at least one database which stores the browsing data and/or the resource locator characteristic indication.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart schematically representing a method for tagging a resource locator based on user behavior statistics, according to some embodiment of the present invention;

FIG. 2 is a system for tagging a resource locator based on user behavior statistics, according to some embodiment of the present invention; and

FIG. 3 is an exemplary web document with presentation of resource locator tagging based on user behavior statistics, according to some embodiment of the present invention.

### DETAILED DESCRIPTION

The present invention, in some embodiments thereof, relates to tagging a resource locator and, more particularly, but not exclusively, to tagging a resource locator based on user behavior statistics.

According to some embodiments of the present invention, there are provided methods and systems of tagging a resource locator, such as a uniform resource locator (URL), based on user behavior statistics. User behavior may be, for example, lingering on a web document, clicking on links, filling forms on the web document or any other action related to the resource locator or the web document associated with the resource locator. This behavior may give indication as for the nature of the web document, for example, the web document may be malicious, safe, interesting, uninteresting, and/or contain inaccurate information. For example, it is assumed that in many cases, a malicious resource locator is discovered as such only after a user browses into the resource locator. After discovering that the resource locator is malicious, the user will usually leave the web document without lingering. Also, a user is unlikely to perform many actions in the web document.

The data is collected of the behavior of users after entering the resource locator and is statistically analyzed. The resource locator is tagged and users are presented with the tag indicating the nature of the resource locator before entering the resource locator, for example, as a visual indication on top of a web document linking to the resource locator.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or to “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

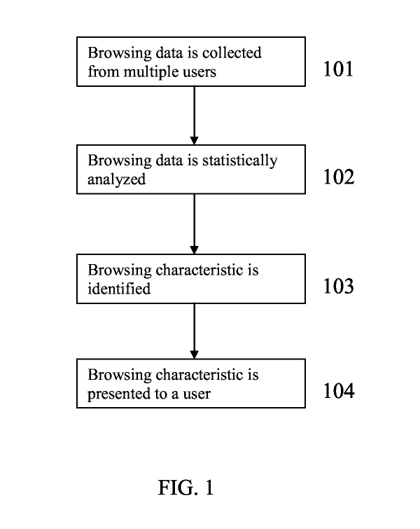

Reference is now made to FIG. 1, which is a flowchart schematically representing a method for tagging a resource locator based on user behavior statistics, according to some embodiment of the present invention. The resource locator directs to a web document that may be, for example, a webpage, an extensible markup language (XML) page, a hypertext markup language (HTML) page, a portable document format (PDF), an executable, an email, an audio and/or video file, an image and/or any other network accessible content file.

First, as shown at 101, browsing data is collected on the behavior of users entering the resource locator. The collection of data may be performed by an application, for example, a plugin or a toolbar installed on each user's browser, a program installed on each user's computer and/or a script operating from a proxy server.

Optionally, the browsing data includes the duration from the user's entering the web document associated with the resource locator and leaving the web document. For example, 1, 20 and/or 40 seconds, 1, 20 and/or 40 minutes and/or 1, 2 and/or 3 hours or any intermediate or longer period. A user's leaving the web document soon after entering it is an indication that it may not have been what the user expected it to be, and possibly malicious or uninteresting.

Optionally, the browsing data includes the number and/or type of actions performed by the user on the web document associated with the resource locator. Such actions are, for example, filling text boxes, filling forms, pressing buttons, pressing links and/or any other option presented on the web document. Multiple actions by the user might indicate that the user believed the web document to be safe. Optionally, the browsing data includes the number of times each action was performed by the user.

Then, as shown at 102, the data from each user is forwarded to a central unit and is statistically analyzed, using a computerized processor. Optionally, this is performed by each application installed on a user's browser or computer by connecting to other instances of the application installed on other users' browser or computer. Optionally, data from each application installed on a user's browser or computer is sent to a central server and analyzed with data sent from other users' applications.

Optionally, only data obtained by the application in recent time is used for the analyzing, for example during the past 1, 12 and 24 hours and/or 1, 2, 10, and/or 100 days or any intermediate or longer period.

Optionally, data obtained by scanning the web document associated with the resource locator for patterns, using algorithms developed for scanning tools, is also analyzed. Such tools may be, for example, malware scanners, tools for static code analysis, code-level anomaly detection tools and/or crawlers which maintain a database of blacklisted websites. Patterns may be, for example, indication of malicious intent such as suspicious words or phrases, known harmful scripts and/or links to known malicious websites.

Optionally, data relating the resource locator that is obtained from social networks is also analyzed, for example, the number of users who posted the resource locator, ranking of the resource locator or comments made by users relating the resource locator. Such social networks are, for example, Facebook, Twitter, and/or other social websites or services.

Optionally, assuming most resource locators of the same website are of similar nature, browsing data of users browsing web documents associated with other resource locators of the same website, server and/or domain name as the original resource locator is also analyzed. For example, if no sufficient data is collected on a specific resource locator, analysis of other resource locators of the website could be an alternative.

Optionally, browsing data of users browsing web documents associated with resource locators linked from the web document associated with the original resource locator is also analyzed. Because a web document is more likely to link to resource locators that are similar in nature, this data may give some indication on the nature of the original resource locator.

Then, as shown at 103, browsing characteristic, is identified according to the analyzed browsing data and optionally other analyzed data as described above. For example, mean and/or maximal time period of staying at a web document and/or mean and/or maximal number of actions performed by users at a web document are calculated. This may be performed by each application installed on a user's browser or computer, or by a central server.

Optionally, sampling is applied while either collecting data, analyzing the data or both. The sampling saves computing resources and prevent overload on the user's computer or browser, while still supply useful characteristic when data is collected from a large group of users.

Then, as shown at 104, a user, browsing a web document that is linking to the resource locator associated with the original web document, is presented with the characteristic indication. The user may then act according to the characteristic indication, for example, by refraining from browsing to the resource locator.

Optionally, the presenting is performed by an application installed on a browser used for loading the linking web document.

Optionally, the browser's security definitions are changed according to the characteristic indication, for example, to disable JavaScript execution or boost privacy settings, therefore, for example, preventing the user from browsing to the resource locator.

Optionally, an execution of a script by the web document is prevented and/or contained according to the characteristic indication, for example, by forcing the script to be executed in a sandbox, in order to protect the user from harmful scripts.

Optionally, the presenting includes visual indication, for example, warning the user from browsing to the first web document by a dialog box, presenting the resource locator characteristic indication next to the link to the resource locator, changing the color of the link and/or marking the link by a strikethrough.

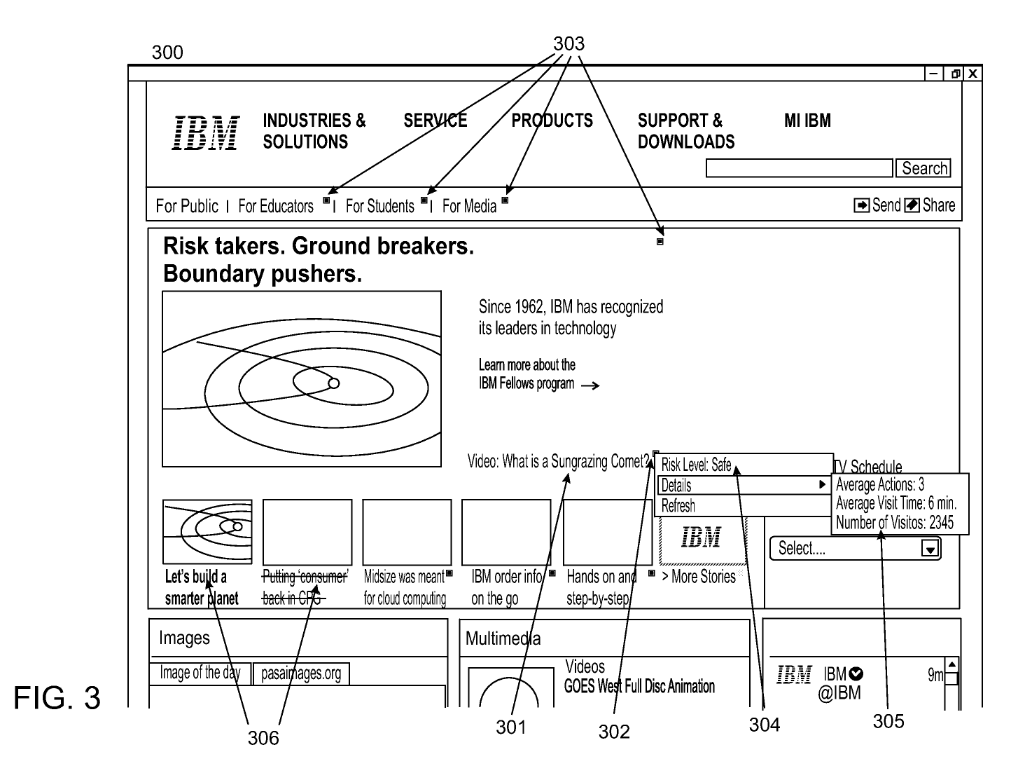

Reference is now made to FIG. 3, which is an exemplary web document 300 with presentation of resource locator tagging based on user behavior statistics, according to some embodiment of the present invention.

A link 301 to a resource locator is tagged with a characteristic indication 302, presented next to the link, according to the analyzing of users' browsing data. Optionally, characteristic indications 303 may have different colors to indicate different indications, for example, different risk levels. Optionally, clicking on characteristic indication 302 presents more information about the indication, for example, written description 304 of the nature of the resource locator, such as safety and/or reliability. Optionally, analyzed browsing data 305 is also presented. Optionally, other tags are possible, as shown at 206.

Optionally, a resource locator is tagged with a targeted characteristic indication according to behavior data collected only or mostly from users socially affiliated with a specific target user, for example, in social networks, and the targeted characteristic indication is presented only to the specific target user. For example, characteristic indication to be presented to a specific user is identified using browsing data collected from users who are friends of the specific user on a social network.

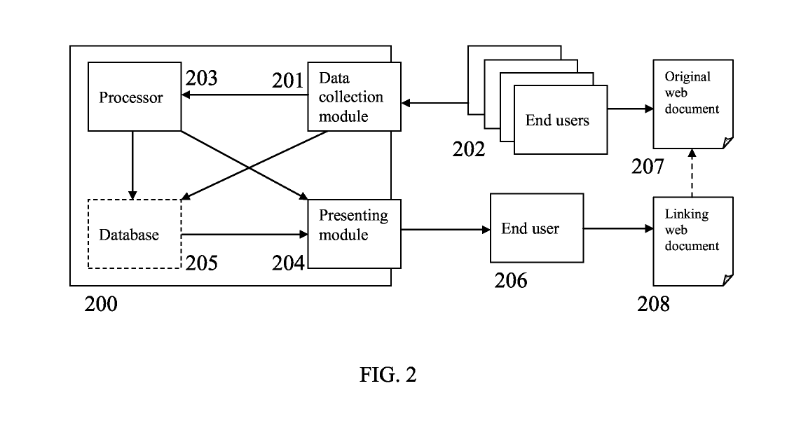

Reference is now made to FIG. 2, which is a system for tagging a resource locator based on user behavior statistics, according to some embodiment of the present invention.

A data collection module 201 of system 200 collects browsing data from end users 202 after each of end users 202 browsed to an original web document 207 associated with a resource locator. The collected data is optionally stored at a database 205. A processor 203 contained in system 200 analyzes the collected browsing data to statistically identify a browsing characteristic for original web document 207. System 200 also comprises a presenting module 204 which presents a characteristic indication of the resource locator associated with original web document 207 in association with a linking web document 208 to a user 206 browsing linking web document 208. Presenting module 204 may be located separately from system 200, for example, in a client terminal of user 206. User 206 may then, for example, refrain from browsing to original web document 207. Optionally, the characteristic indication is stored at database 205.

In an exemplary process of tagging a resource locator based on user behavior statistics, according to some embodiment of the present invention, a plugin that is installed on users' browser is collecting data on the users' behavior after entering a URL-1 to an HTML webpage-1. The data includes the time spent by users on webpage-1. The dada is analyzed and it is determined that the mean time spent on webpage-1 is 13 seconds. As this is a relatively short time, URL-1 is tagged as potentially risky. Webpage-2, linking to URL-1 is viewed by a user using a browser with the plugin installed. When the user clicks on the link to URL-1, the plugin prompt a message for the user, warning the user from entering URL-1.

The methods as described above are used in the fabrication of integrated circuit chips.

The flowchart and block diagrams in the figures illustrate the architecture, functionality, and operation of possible implementations of systems, methods and to computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant resource locator tagging methods will be developed and the scope of the term resource locator tagging is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed to composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, to which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for tagging a resource locator based on user behavior statistics, comprising:
collecting browsing data on at least one browsing action taken by each of a plurality of end users after browsing to a first web document, said first web document is referenced to by a resource locator in a second web document;
analyzing, using a computerized processor, said browsing data to statistically identify a browsing characteristic of said first web document; and
instructing the presentation of an indication of said browsing characteristic in association with a presentation of said second web document by a browser installed in a client terminal to a user browsing to said second web document.

2. The method of claim 1, wherein said browsing data include a time duration spent by each of said plurality of end users at said first web document.

3. The method of claim 1, wherein said browsing data include a number of browsing actions performed by each of said plurality of end users at said first web document.

4. The method of claim 1, wherein said collecting comprise:
compiling a group of socially affiliated users; and
collecting browsing data from said group of socially affiliated users.

5. The method of claim 1, wherein said collecting is performed on some of said browsing data to minimize computing load.

6. The method of claim 1, wherein said collecting of browsing data is performed by a browser plugin installed on said browser.

7. The method of claim 1, wherein said analyzing further include data obtained by scanning a content of said first web document for patterns relating to said browsing characteristic.

8. The method of claim 1, wherein said analyzing further include data concerning a posting of said resource locator on social networks.

9. The method of claim 1, wherein said analyzing further include analyzing browsing data of each of a plurality of end users after browsing to other web documents of the same website as said first web document.

10. The method of claim 1, wherein said analyzing further include browsing data of each of a plurality of end users after browsing to web documents linked from said first web document.

11. The method of claim 1, wherein said analyzing is performed on some of said browsing data to minimize computing load.

12. The method of claim 1, wherein said analyzing is performed by a central server after receiving said browsing data from a plurality of client terminals of said plurality of end users.

13. The method of claim 1, wherein said presenting is performed by a browser plugin installed on said browser.

14. The method of claim 1, wherein said presenting includes visual indication warning said user from browsing to said first web document.

15. The method of claim 1, wherein said presenting includes presenting of said analyzed browsing data.

16. The method of claim 1, further comprising changing security definitions of said browser based on said browsing characteristic.

17. The method of claim 1, further comprising at least one of preventing and containing an execution of a script by said first web document based on said tagging.

18. A computer readable medium comprising computer executable instructions adapted to perform the method of claim 1.

19. A system for tagging a resource locator based on user behavior statistics, comprising:
at least one data collection module which collects data on at least one browsing action taken by each of a plurality of end users after browsing to a first web document associated with a resource locator, said first web document is referenced to by a resource locator in a second web document;
a computerized processor which analyzes said browsing data to statistically identify a browsing characteristic of said first web document; and
a presenting module which instructs the presentation of an indication of said browsing characteristic in association with the presentation of said second web document by a browser installed in a client terminal to a user browsing to said second web document.

20. The system of claim 19, further comprising at least one database which stores said browsing data and/or said resource locator characteristic indication.
